(19) United States
(12) Patent Application Publication
(10) Pub. No.: US 2006/0055605 A1
(43) Pub. Date: Mar. 16, 2006

(54) Cavity antenna with reactive surface loading

(76) Inventors: Asher Peled, Even Yehuda (IL); Ehud Heyman, Tel Aviv (IL); Ben-Zion Steinberg, Kfar Saba (IL); Raphael Kastner, Hod Hasharon (IL); Amir Boag, Yavne (IL)

Correspondence Address: DARBY & DARBY P.C., P. O. BOX 5257, NEW YORK, NY, 10150-5257, US

(21) Appl. No.: 10/416,436

(22) PCT Filed: Dec. 12, 2001
(86) PCT No.: PCT/IL01/01152

§ 371 Date: Sep. 22, 2003

Related U.S. Application Data
(60) Provisional application No. 60/255,570, filed on Dec. 14, 2000.
(60) Provisional application No. 60/303,923, filed on Jul. 6, 2001.

(51) Int. Cl. H01Q 1/24

(52) U.S. Cl. 343/702

(57) ABSTRACT

An antenna assembly (30) for a communication device (20) includes a feed structure (25), which has front and rear sides (26, 27), and which is coupled to be driven by the device so as to radiate an electromagnetic field in a given frequency band. An electrically reactive surface (28) is positioned adjacent to the rear side of the feed structure so as to define a cavity (35) between the feed structure and the reactive surface, thereby substantially nulling the electromagnetic field on the rear side of the feed structure.

### CROSS-REFERENCE TO RELATED APPLICATIONS

This application claims the benefit of U.S. Provisional Patent Application No. 60/255,570, filed Dec. 14, 2000, and U.S. Provisional Patent Application No. 60/303,923, filed Jul. 6, 2001. It is related to a PCT patent application entitled, “Antenna with Virtual Magnetic Wall,” filed Dec. 6, 2001. All of these related applications are assigned to the assignee of the present patent application, and their disclosures are incorporated herein by reference.

### FIELD OF THE INVENTION

The present invention relates generally to antennas, and specifically to devices and methods for controlling the Specific Absorption Rate (SAR) of radiation from the antenna of a mobile communication device in the tissues of a user of the device.

### BACKGROUND OF THE INVENTION

Concern has been growing over the radiation hazard involved in use of cellular telephones. Complaints of headaches, dizziness and fatigue are common among heavy users of cellular phones. Recent studies have indicated that long exposure to radio frequency (RF) radiation emitted by cellular phone antennas could cause serious medical problems due to the interference with brain cell activity, possibly leading to brain cancer. Some governments have already started warning users in regard to risks associated with use of cell phones. Recently, the British government has issued a recommendation to parents to limit the time their children use mobile phones. In the United States and in other countries, cellular and other wireless handsets must meet regulatory requirements for maximum specific absorption rate (SAR) levels in body tissues.

The concerns about the adverse health effects of cellular phone use arise from the fact that their antennas can deliver large amounts of RF energy to very small areas of the user's brain. In many cases, over 70% of the electromagnetic power emitted by the antenna in the 800-900 MHz band is absorbed in the human head. Although the RF emissions of wireless handsets are classified as non-ionizing, they are able to transfer energy in the form of heat to any absorptive material. The antenna location, near field emission characteristics, radio frequency power, and frequency establish the basis for conformance to SAR limits. Energy absorption in the head also introduces extra loss into the power budget of the cellular phone itself, causing increased power consumption and reduced battery life for a given levee of antenna emission.

Some attempts to reduce the health hazards of radio telephone antennas use RF-absorbing materials to shield the head. For example, U.S. Pat. Nos. 5,666,125 and 5,777,586, whose disclosures are incorporated herein by reference, describe an antenna assembly that includes a radiation absorber defining an open curved shape. At least some of the radiation emitted from the antenna in directions toward the user is blocked by the radiation absorber. Similarly, U.S. Pat. No. 5,694,137, whose disclosure is incorporated herein by reference, describes an arc-shaped shield, made of material impervious to radiation, which is positionable along an exterior of an antenna. While such absorbing shields may reduce the SAR in the head, however, they only aggravate the power loss problem. Therefore, an optimal antenna design should be based on improving efficiency of the radiation pattern as the key means for reducing SAR in body tissues.

As an alternative to absorbing materials, manufacturers often use electrically-conducting (grounded) surfaces to shield the user from the antenna. For example, U.S. Pat. No. 6,088,579 describes a radio communication device that has a conductive shielding layer between the antenna and the user. The shielding layer may be movable away from the antenna when not in use. Similarly, U.S. Pat. No. 5,613,221 describes a radiation shield for a hand-held cellular telephone made of a metal strip placed between the antenna rod of the telephone and the user. U.S. Pat. No. 6,075,977 describes a dual-purpose flip shield for retrofit to an existing hand-held cellular telephone. The shield, made of a polished material, preferably aluminum, is flipped up to a position between the telephone antenna and the user's head when the telephone is in use so as to provide high reflectance of electromagnetic waves away from the user. Other conductive antenna shielding devices are described in U.S. Pat. Nos. 6,088,603, 6,137,998, 6,097,340, 5,999,142 and 5,335,366. The disclosures of all the patents mentioned in this paragraph are incorporated herein by reference.

Conductive shields of the types described in these patents are not very effective in redirecting antenna energy, however, particularly when monopole antennas are involved. The problems with conductive shields stem from the fact that the boundary condition of the electromagnetic fields on a conductive surface requires the total electric field tangential to the surface to be zero. Therefore, the conductive surface necessarily has a reflection coefficient with a phase shift of 180° in the electric field. For the direct and reflected fields to be in phase, so that the antenna field is not canceled (shorted out) by destructive interference, the distance between the antenna and the reflector must be one quarter wave, which is about 8 cm in the 800-900 MHz band. To implement this solution with a monopole antenna is cumbersome, since the reflecting element must be located between the user and the antenna, meaning that the antenna itself must be at least 8 cm from the user's head.

In view of the known drawbacks of conductive reflectors, there have been attempts to improve their performance by addition of other electrical elements. For example, U.S. Pat. No. 6,114,999, whose disclosure is incorporated herein by reference, describes an antenna device for a mobile phone, wherein a distance between a miniaturized radiator and a miniaturized reflector is shortened by means of an introduced dielectric material. As an additional means for reducing the field directed toward the user, at least two thin isolated metal strips run parallel to the edges of the reflector element to form chokes at the rear of the reflector, so as to concentrate the near-field to an area between the chokes. European Patent Application EP 0 588 271 A1, whose disclosure is likewise incorporated herein by reference, describes an antenna for a portable transceiver having an asymmetric radiation pattern. At least one reflector can be placed in a rear zone of the antenna radiator. It is suggested that the reflector can be made of tuned dipoles operating in a passive manner, or by a vertical reflecting screen composed of densely-spaced horizontal turns.

Other antenna designs, such as patch antennas and variants on the loop antenna, permit more design flexibility without resorting to cumbersome reflector elements. These designs, however, have not shown the necessary near-field behavior to reduce SAR in the head. Another practice known in the art is to generate a quasi-directional far-field free-space pattern, rather than an omni-directional pattern. For example, U.S. Pat. No. 6,031,495, whose disclosure is incorporated herein by reference, describes an antenna system for reducing SAR that uses a pair of phased radiating elements to create a bi-directional radiation pattern with high attenuation perpendicular to the user's head. In the near field, however, the RF power density toward the user is not necessarily reduced by such an approach.

### SUMMARY OF THE INVENTION

It is an object of the present invention to provide improved structures and methods for creating antennas having asymmetrical magnetic and/or electric near field distributions.

It is a further object of some aspects of the present invention to provide antenna assemblies with enhanced near-field directional characteristics.

It is yet a further object of some aspects of the present invention to provide apparatus and methods for reducing the SAR of RF radiation emitted by a personal communication device, such as a cellular telephone, in the head of a user of the device.

It is still a further object of some aspects of the present invention to provide antenna assemblies for use with personal communication devices that reduce the overall device power budget.

In preferred embodiments of the present invention, an antenna for a personal communication device comprises a feed structure, which is driven by the device to radiate an electromagnetic field in the operating frequency band of the device. A reactive surface is positioned adjacent to the rear surface of the feed structure, between the feed structure and the user's head. An electrically-asymmetrical cavity is thus defined between the rear surface of the feed structure, which is typically conductive, and the reactive surface adjacent to it.

The asymmetrical cavity supports two parallel current distributions in the conductive surface and the reactive surface, running in opposite directions (i.e., out of phase) on the two surfaces. On the front side of the feed structure, only the current on the conductive surface has an effect, thereby creating a strong field on the front side of the assembly, away from the user's head. The effect of the other current, running on the reactive surface, is shielded by the conductive surface. On the rear side of the feed structure, however, a null field is created in the cavity, since the individual effects of the currents on the conductive and reactive surfaces cancel one another.

Preferably, the feed structure is designed so as to minimize its size relative to the operating frequency. In some preferred embodiments of the present invention, the feed structure comprises a miniature cavity or, preferably, an array of such cavities, having a resonant frequency in the operating frequency band of the device. In other preferred embodiments of the present invention, the feed structure comprises a reduced-height monopole feed or an inverted-F feed, preferably with a meandered structure. Alternative feed structures will be apparent to those skilled in the art.

The novel combination of the feed structure with the asymmetrical cavity provides strong asymmetry of the near-field distribution of the electromagnetic energy radiated by the antenna assembly. Therefore, absorption of radiation from the antenna in the user's head is reduced. The electrical and mechanical characteristics of these feed structure and reactive surface allow the antenna assembly to be made small in size, with minimal impact on the mechanical design of the communication device. Furthermore, because both the feed structure and the reactive surface are substantially non-absorbing of radiation, the antenna structure radiates energy efficiently. By “reclaiming” energy that would otherwise be absorbed in the user's head, the antenna assembly improves the overall power budget of the communication device.

Although preferred embodiments described herein are directed to personal communication devices, and particularly to protecting users of such devices from RF radiation emitted by device antennas, the usefulness of the present invention is by no means limited to such applications. Rather, the principles and techniques of the present invention may be applied to produce near-field directional antenna assemblies for other uses, as well.

There is therefore provided, in accordance with a preferred embodiment of the present invention, an antenna assembly for a communication device, the assembly including:
a feed structure, which has front and rear sides, and which is coupled to be driven by the device so as to radiate an electromagnetic field in a given frequency band; and
an electrically reactive surface which is positioned adjacent to the rear side of the feed structure so as to define a cavity between the feed structure and the reactive surface, thereby substantially nulling the electromagnetic field on the rear side of the feed structure.

Preferably, the feed structure and reactive surface are adapted to be mounted on the communication device so that the reactive surface intervenes between the feed structure and a head of a user of the device and shields the head from the radiated field.

Typically, the reactive surface includes an array of reactive circuit elements, including inductors and/or capacitors. In preferred embodiments, the reactive surface includes a printed circuit board having a plurality of faces in one or more layers, and the reactive circuit elements include traces printed on at least two of the faces of the printed circuit board. Preferably, the traces are printed so as to define inductive coils or, alternatively or additionally, so as to define parallel-plate or interdigitated capacitors. The reactive circuit elements may be mutually connected in series or in parallel.

Preferably, the reactive surface has a resonant response in the given frequency band. Further preferably, the rear side of the feed structure is substantially planar, and the reactive surface is positioned substantially parallel to the rear side of the feed structure. In a preferred embodiment, the feed structure further has an upper surface, and the reactive surface is configured and positioned so as to substantially cover the upper surface of the feed structure.

In some preferred embodiments, the front and rear sides of the feed structure define at least one resonant cavity therebetween having a resonance in the given frequency band and opening through at least one aperture in the front side of the feed structure, through which aperture the electromagnetic field radiates when the feed structure is driven by the device. Preferably, the at least one resonant cavity includes an array of cavities.

Preferably, the feed structure includes at least one transmission line, which is configured to form the at least one resonant cavity between the front and rear sides. Most preferably, the at least one transmission line defines a waveguide that forms the resonant cavity. Typically, the at least one transmission line is configured to form a spiral shape or is meandered. In a preferred embodiment, the transmission line is configured so that the at least one resonant cavity has corners, and including corner elements in the corners of the resonant cavity, which are arranged to inhibit reflection of the electromagnetic radiation at the corners of the at least one cavity. Preferably, the at least one transmission line is configured so that the resonant cavity has an electrical length approximately equal to one quarter wave in the given frequency band.

In a preferred embodiment, the at least one aperture includes a plurality of apertures. In a further preferred embodiment, the feed structure further includes one or more lumped circuit elements coupled across the at least one aperture. Additionally or alternatively, the feed structure includes one or more fins, positioned in the at least one resonant cavity so as to enhance a capacitance of the cavity. Further additionally or alternatively, the feed structure includes at least one of a dielectric material and a magnetic material, which is contained in the at least one resonant cavity.

In another preferred embodiment, the feed structure includes top and side surfaces, and further includes an awning protruding over at least one of the top and side surfaces so as inhibit leakage of the electromagnetic radiation toward the rear side of the structure. Preferably, the feed structure includes a capacitor positioned adjacent to the awning so as to enhance inhibition of the leakage of the electromagnetic radiation toward the rear side.

In still another preferred embodiment, the feed structure includes a monopole feed structure. In yet another preferred embodiment, the feed structure includes an inverted-F feed structure, wherein the front side of the feed structure includes a meandered electrical conductor.

Preferably, the rear side of the feed structure is electrically conductive.

There is also provided, in accordance with a preferred embodiment of the present invention, a method for wireless communication using a communication device operating in a given frequency band, the method including:
coupling a feed structure, having a front side and a rear side, to the communication device, so that the feed structure can be driven by the device to radiate an electromagnetic field in the given frequency band; and
positioning an electrically-reactive surface adjacent to the rear side of the feed structure, so as to define a cavity between the feed structure and the reactive surface, thereby substantially nulling the electromagnetic field on the rear side of the feed structure.

The present invention will be more fully understood from the following detailed description of the preferred embodiments thereof, taken together with the drawings in which:

### BRIEF DESCRIPTION OF THE DRAWINGS

FIG. 1 is a schematic, pictorial illustration of a cellular telephone with an antenna assembly, in accordance with a preferred embodiment of the present invention;

FIG. 2 is a schematic, partly cutaway, pictorial illustration showing details of an antenna assembly, in accordance with a preferred embodiment of the present invention;

FIG. 3A is a schematic front view of a reactive surface used in an antenna assembly, in accordance with a preferred embodiment of the present invention;

FIG. 3B schematically shows details of the reactive surface shown in FIG. 3A;

FIGS. 3C and 3D are schematic, pictorial illustrations showing details of reactive surfaces used in antenna assemblies, in accordance with further preferred embodiments of the present invention;

FIGS. 4 and 5 are schematic, partly cutaway, pictorial illustrations showing antenna assemblies, in accordance with preferred embodiments of the present invention;

FIG. 6A is a schematic, sectional view of an antenna assembly, in accordance with another preferred embodiment of the present invention;

FIG. 6B is a schematic, top view of an inter-cavity surface in the assembly of FIG. 6A;

FIG. 7 is a schematic, sectional view of an antenna assembly, in accordance with still another preferred embodiment of the present invention;

FIG. 8 is a cross-sectional view of the antenna assembly of FIG. 7;

FIG. 9 is a schematic, sectional view of an antenna assembly, in accordance with still another preferred embodiment of the present invention;

FIGS. 10A and 10B are schematic, sectional views of antenna assemblies, in accordance with further preferred embodiments of the present invention; and

FIG. 11A is a schematic pictorial view of an antenna assembly, in accordance with yet another preferred embodiment of the present invention;

FIGS. 11B and 11C are, respectively, schematic front and side views of the antenna assembly of FIG. 11A; and

FIGS. 12A and 12B are, respectively, schematic pictorial and side views of an antenna assembly, in accordance with still another preferred embodiment of the present invention.

### DETAILED DESCRIPTION OF PREFERRED EMBODIMENTS

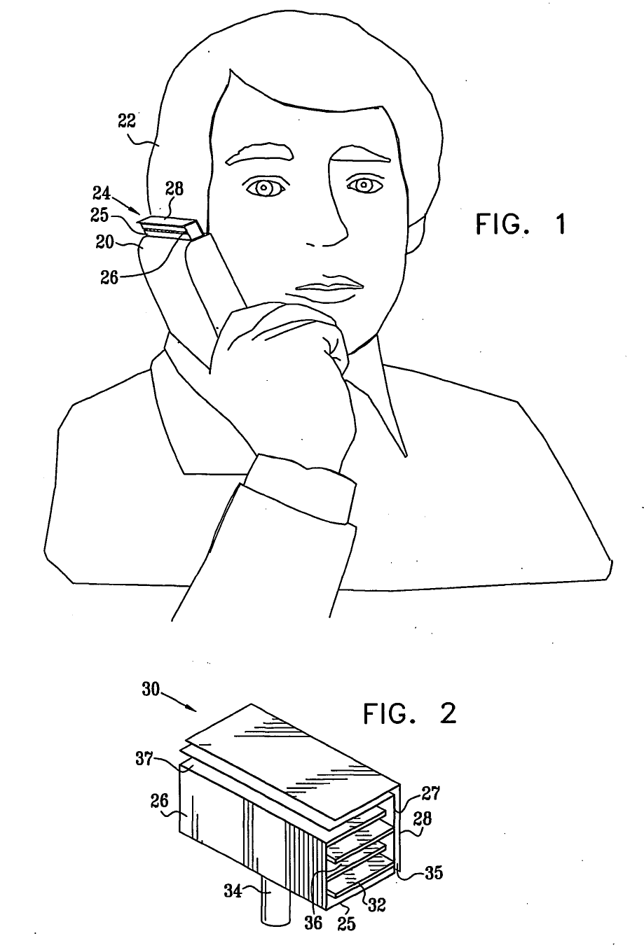

FIG. 1 is a schematic, pictorial illustration showing a cellular telephone 20 held next to a head 22 of a user, in accordance with a preferred embodiment of the present invention. Telephone 20 comprises an antenna assembly 24, made up of a feed structure 25 and an electrically-reactive shielding surface 28. Feed structure 25 has a front surface 26 and a rear surface, not seen in this figure. Here and in the description that follows, the “front surface” of the feed structure (or the antenna assembly) refers to the side of the assembly that is generally pointed away from head 22, as shown in the figure, while the “rear surface” faces toward the head. The rear surface of feed structure 25, which is typically conductive, and reactive surface 28 together define an asymmetrical cavity therebetween. Various realizations of the feed structure and the asymmetrical cavity are shown in detail in the figures that follow.

The combination of the asymmetrical cavity and the feed structure causes the near field of the antenna assembly to be strongly asymmetrical, with a sharp drop of the magnetic and/or electric field between high values at the front of the assembly and very low values at the rear. The design of the antenna assembly not only reduces absorption of radiation in the head, but also redirects the energy supplied to the feed structure into the communication channel, thereby improving the overall power budget of telephone 20.

FIG. 2 is a schematic, pictorial illustration showing an antenna assembly 30, in accordance with a preferred embodiment of the present invention. The assembly is shown in cutaway view, without side walls, in order to reveal its internal structure. In this embodiment, feed structure 25 comprises a single radiating cavity 36, which is fed from telephone 20 by a feed line 34 and opens through an aperture 37, typically a slot, in front surface 26 of the feed structure. The cavity is formed by a folded, meandered transmission line 32, which acts as a shorted transmission line or waveguide with an equivalent electrical length of one quarter wave in the operating band of telephone 20. (Equivalently, the cavity may be viewed as a resonant circuit, with appropriate values of inductance and capacitance to give a resonance in the operating band.) Transmission line 32 is preferably folded tightly in order to minimize the total volume of cavity 36, while still providing the desired quarter wave cavity length. Typical dimensions of the cavity for operation in the 800-900 MHz cellular band are 42 mm width×20 mm height×8 mm depth. The cavity may be filled with a dielectric or magnetic material, with a relative permittivity or permeability, respectively, in the range of 1 to 20, or possibly higher. Either natural or artificial magnetic materials may be used.

An asymmetrical cavity 35 is defined by reactive surface 28, positioned adjacent to a rear surface 27 of feed structure 25. Preferably, the reactive surface bends over the top of feed structure 25, as well, to further reduce radiation that may reach the user's head from the top of the feed structure. As noted above, cavity 35 supports two parallel current distributions in conductive rear surface 27 and in reactive surface 28. The current distributions run in opposite directions (i.e., out of phase) on the two surfaces. At front surface 26 of feed structure 25, only the current at conductive surface 27 has an effect, thereby creating a strong field on the front side of antenna assembly 30, away from the user's head. On the front side of the antenna assembly, the effect of the current on reactive surface 28 is shielded by conductive surface 27. On the rear side of feed structure 25, however, a null field is created in cavity 35, since the individual effects of the currents on conductive surface 27 and reactive surface 28 cancel one another.

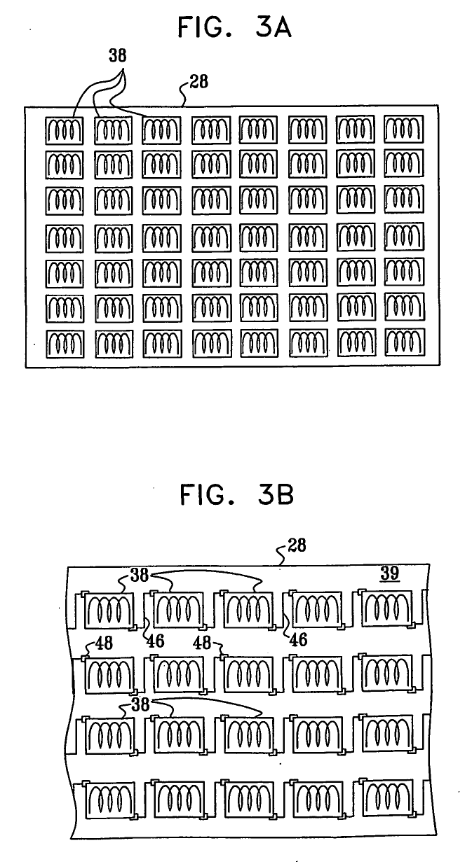

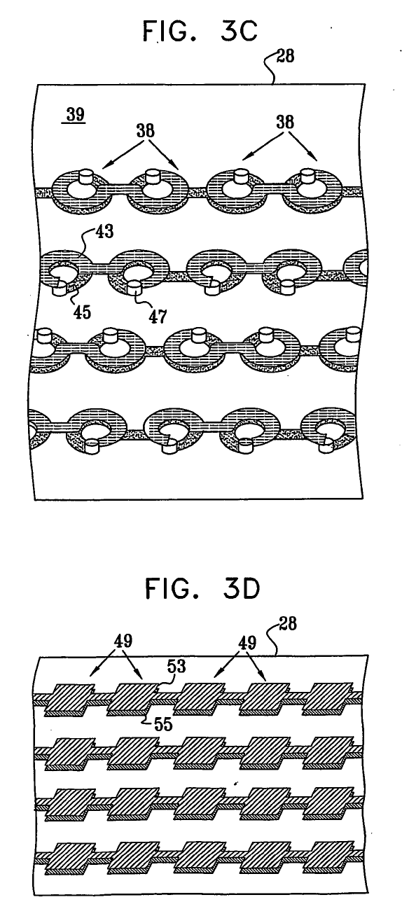

FIGS. 3A and 3B schematically illustrate reactive surface 28, in accordance with preferred embodiment of the present invention. FIG. 3A is a generalized front view of surface 28, while FIG. 3B shows details of the surface. Reactive surface 28 comprises an array of lumped inductors 38, which are preferably soldered to the surface. As shown in FIG. 3B, the shield preferably comprises a printed circuit board 39 with pads 48 for soldering inductors 38 to the board. The inductors are preferably connected in series by printed circuit traces 46. In another embodiment, shown in FIG. 3C, the printed circuit board itself has inductive coils printed on its surface, in addition to or instead of the soldered inductors.

The inductance values of inductors 38 and their positions are chosen so that the field emitted by feed structure 25 excites cavity 35, causing an electric current to flow at reactive surface 28 in opposite phase to the electric current on conductive surface 27. The current flowing at the reactive surface thus nulls the electromagnetic field at the rear of feed structure 25. In this sense, reactive surface 28 acts as a virtual magnetic wall (VMW), as described in the above-mentioned PCT patent application entitled, “Antenna with Virtual Magnetic Wall.” Alternative VMW structures, as described in that application, may be used in reactive surface 28 in place of the inductor array shown in FIG. 3.

The values of inductors 38 and their spacing are chosen to give a resonant response in the operating frequency band (or bands) of telephone 20. Typically, for operation in the 800-900 MHz cellular band, the unit cell of the inductor array on surface 28 is 4 mm×4 mm, having lumped inductors of L=8.3 nH. In another example, the unit cell is 3.5 mm×3.5 mm, and the value of the inductors is L=10 nH. The depth of cavity 35 is preferably 2 mm. In other embodiments, capacitors may be used, as well as inductors. The addition of capacitors is particularly useful when the antenna assembly must be designed for dual-band operation.

FIG. 3C is a schematic, pictorial illustration showing a detail of reactive surface 28, in accordance with another preferred embodiment of the present invention. In this embodiment, surface 28 is made from a printed circuit board 39, on which inductors 38 in the form of coils are printed in series. Each coil comprises an upper segment 43, printed on an upper layer or side of printed circuit board 39, and a lower segment 45, printed on a lower layer or side of the board. The upper and lower segments are joined by feedthroughs 47. Optionally, unused areas of printed circuit board 39, such as the centers of the coils, are drilled through. Other methods for forming inductor arrays will be apparent to those skilled in the art.

FIG. 3D is a schematic, pictorial illustration showing a detail of reactive surface 28, in accordance with still another preferred embodiment of the present invention. Here capacitors 49 are formed by parallel plates 53 and 55, printed on respective upper and lower layers or sides of printed circuit board 39. Capacitors 49 are mutually connected in parallel. Alternatively, the capacitors may be connected in series, and may comprise chip capacitors soldered onto board 39 or other printed capacitor structures, such as interdigitated capacitors. Although for the sake of simplicity, FIG. 3D shows only capacitors, typically such capacitive elements are used together with inductive elements, such as those shown in the preceding figures, to form a combined reactive surface.

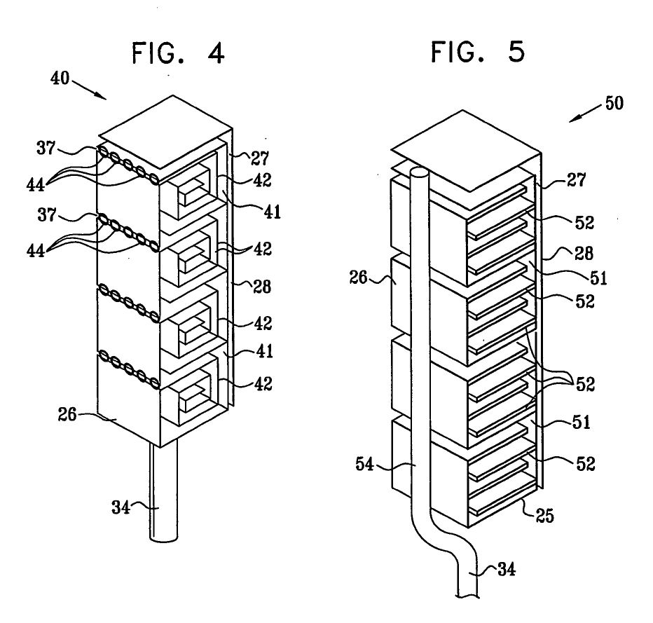

FIG. 4 is a schematic, partly cutaway, pictorial illustration showing an antenna assembly 40, in accordance with another preferred embodiment of the present invention. In this embodiment, feed structure 25 comprises an array of cavities 41, formed by spiral transmission lines 42. The lines are preferably wound tightly and configured to be one quarter wave in equivalent electrical length at the operating wavelength of telephone 20, as described above with reference to FIG. 2. Optionally, lumped elements 44, typically capacitors, are coupled across apertures 37 at the openings of cavities 42. The use of these lumped elements enables the size of cavities 41 to be reduced, while maintaining a desired performance level of the antenna assembly. Although lumped elements 44 are shown explicitly only in FIG. 4, they may be added to any of the other embodiments shown here, to similar effect.

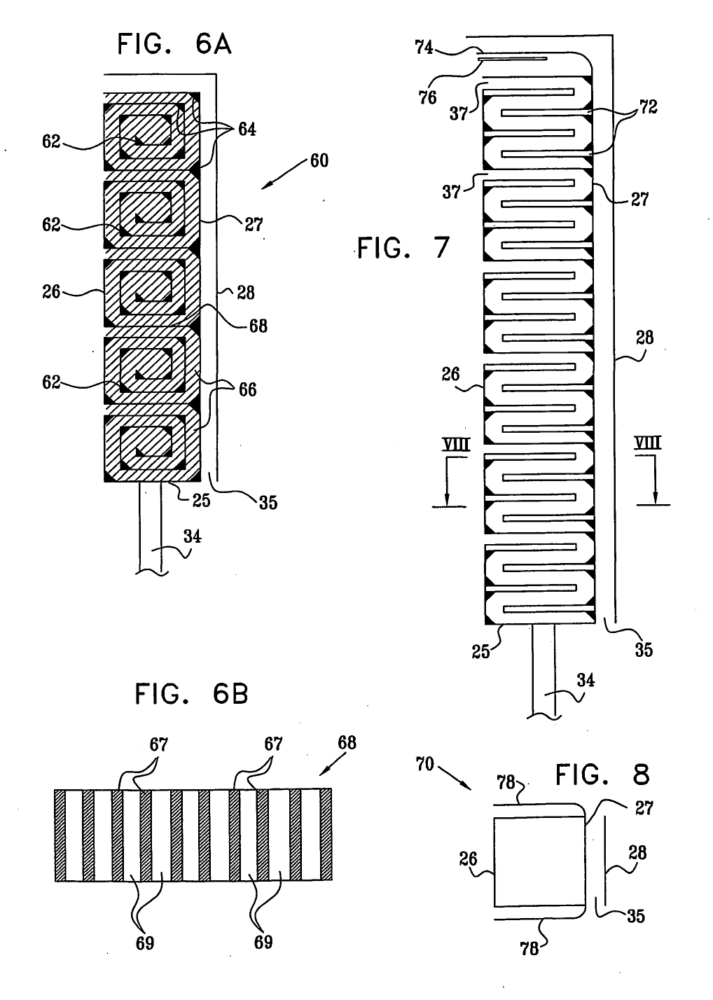

Feed line 34 preferably comprises a coaxial cable, which is connected to the bottom cavity 41. Alternatively, the feed line may protrude through the bottom cavity and connect to some or all of the upper cavities. The cavities that are not directly connected to the feed line are excited by coupling through apertures 37 and lumped elements 44. Alternatively or additionally, the walls separating cavities 41 may be replaced by a combination of perforation and wires, in a manner similar to that shown in FIG. 6B, below, in order to enhance inter-cavity coupling.

Although feed line 34 is shown in FIG. 4 as being connected to cavities 42 from within, it can also be configured to serve as a monopole antenna. In this case, the feed line is placed in front of the cavities (as shown in FIG. 5), and the structure made up of the cavities, lumped elements 44 and reactive surface 28 acts as a reflector, in a manner similar to that described in the above-mentioned PCT and provisional patent applications.

FIG. 5 is a schematic, partly cutaway, pictorial illustration showing an antenna assembly 50, in accordance with yet another preferred embodiment of the present invention. In this embodiment, feed structure 25 comprises an array of cavities 51 formed by meandered transmission lines 52. Feed line 34 feeds a monopole antenna 54 adjacent to front surface 26. Cavities 51 act as in-phase reflectors of the field radiated by the monopole antenna, as described above.

FIG. 6A is a schematic, sectional view of an antenna assembly 60, in accordance with still another preferred embodiment of the present invention. Here, too, feed structure 25 comprises an array of cavities formed by spiral transmission lines 62. In order to ensure that the field propagates through each cavity without interruption, solid triangular conductors 64 are inserted in the corners (or bends) of each spiral. Conductors 64 prevent back-reflections of the field at the corners of the cavities, so that substantially the only reflection of the field occurs at the end of the propagation path, in the geometrical center of each spiral. As a result, the net phase difference along the propagation path is approximately 90°.

The cavities formed by transmission lines 62 are preferably filled with a dielectric or magnetic material 66, in order to reduce the physical length of the transmission lines needed to provide the proper quarter-wave electrical length. Feed structure 25 can thus be made still more compact. Dielectric or magnetic materials may similarly be used in the cavities of feed structure 25 in other preferred embodiments of the present invention.

FIG. 6B is a top view of one of walls 68 separating the cavities formed by transmission lines 62 in antenna assembly 60, in accordance with a preferred embodiment of the present invention. In order to enhance inter-cavity coupling, wall 68 is made up of conductive strips 67, separated by openings 69. Other perforated structures may also be used for this purpose.

FIGS. 7 and 8 schematically illustrate an antenna assembly 70, in accordance with a further preferred embodiment of the present invention. FIG. 7 is a sectional side view, while FIG. 8 is a cross-sectional top view, taken along a line VIII-VIII in FIG. 7. Feed structure 25 comprises an array of meandered transmission lines 72 (with triangular conductors in the corners, as in FIG. 6). The feed structure includes a top awning 74 and side awnings 78, made of a conductive material, which provide additional blockage against leakage from apertures 37 to the rear of the feed structure. A capacitor 76 is preferably inserted adjacent to top awning 74 in order both to help match the impedance of the feed structure to feed line 34 and to enhance the blockage of radiation in this direction. Similar capacitors may be added to the side awnings. Again, awnings of the types shown in FIGS. 7 and 8 may similarly be added to the feed structures used in other preferred embodiments of the present invention. The top and side awnings may be used together, as in assembly 70, or individually.

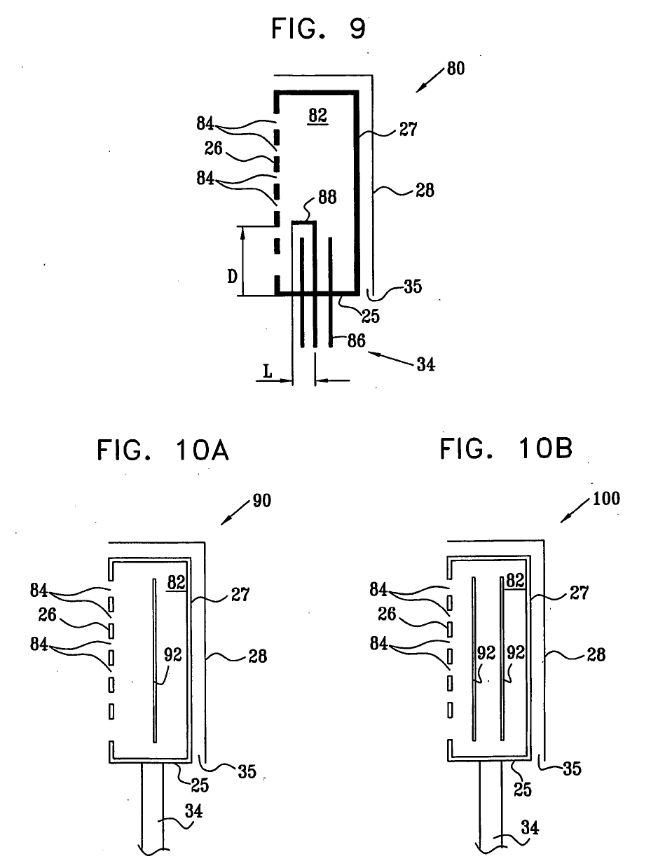

FIG. 9 is a schematic, sectional view of an antenna assembly 80, in accordance with another preferred embodiment of the present invention. Here feed structure 25 comprises a single cavity 82, with multiple apertures 84 in front surface 26. There are preferably between one and eight apertures in surface 26, but greater numbers of apertures may also be used, in a variety of different positions and orientations in the surface. Lumped elements and dielectric fill may be used in this embodiment, as in the embodiments described above. Feed line 34 preferably comprises a coaxial cable 86, which protrudes a distance D into cavity 82 and feeds a pin 88 of length L.

The values of D and L, as well as the dimensions of cavity 82, depend on the desired center resonant frequency and bandwidth of the feed structure. For operation in the 800-900 MHz cellular band, for example, typical dimensions of cavity 82 are 42 mm wide×20 mm high×8 mm deep. The cavity can be filled with dielectric or magnetic materials with relative permittivity or permeability, respectively, of 1 to 20 or higher. Coaxial cable 86 protrudes 25-35 mm into the cavity, and pin 88 is 2-5 mm long.

FIGS. 10A and 10B are schematic, sectional views of antenna assemblies 90 and 100, respectively, in accordance with preferred embodiments of the present invention. These assemblies are similar in design and operation to assembly 80, shown in FIG. 9, but further include one or more conductive fins 92 within their cavities 82. The fins increase the capacitance of the cavities and thus enhance their radiative efficiency relative to their size. Fins 92 may comprise either solid conductive sheets or combinations of perforations and wires, as described above.

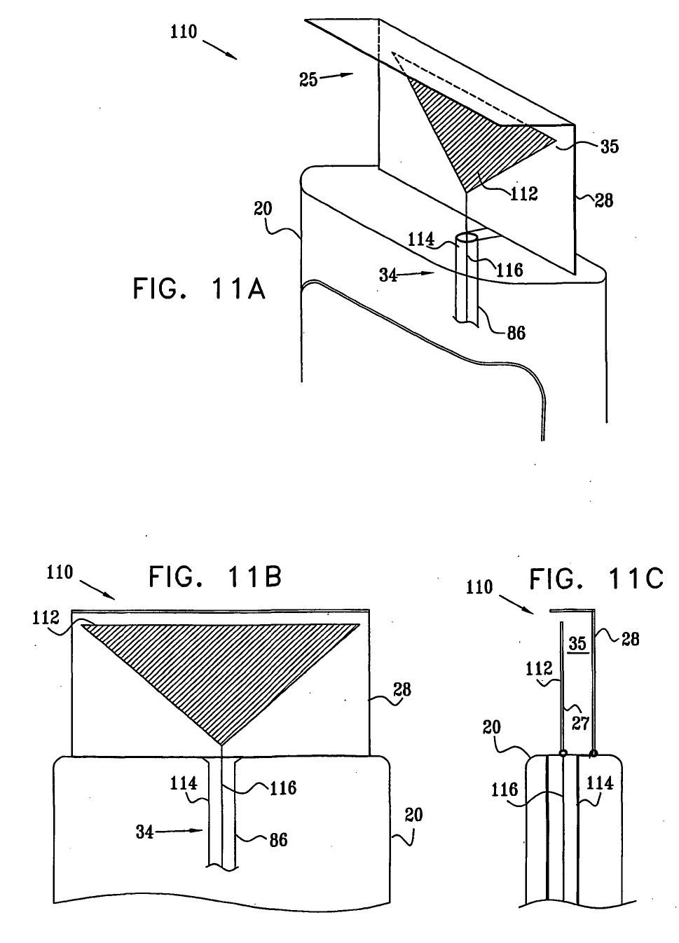

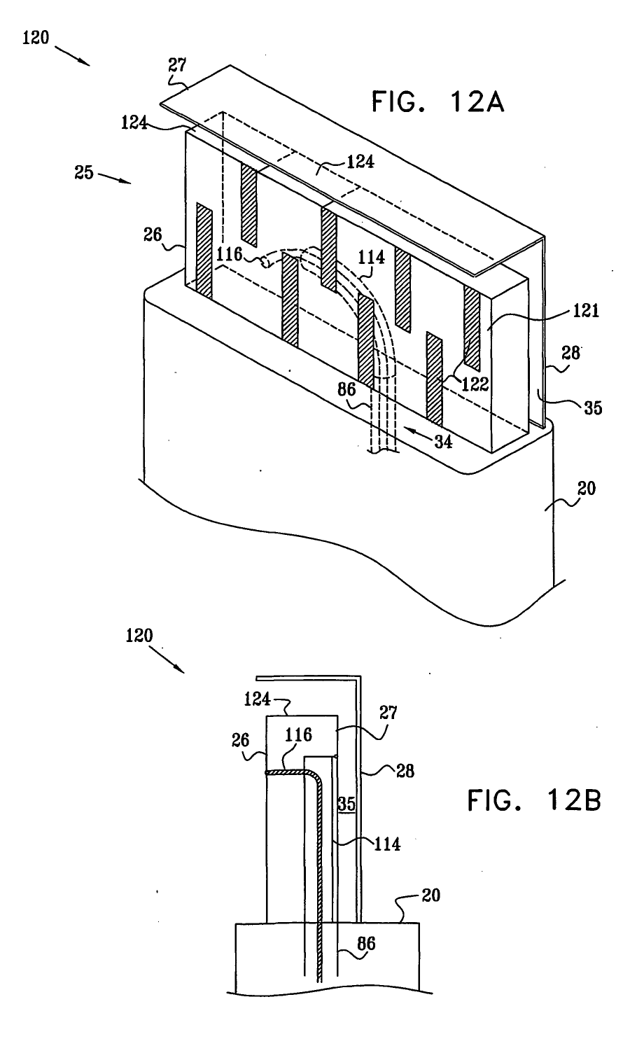

FIGS. 11A, B and C schematically illustrate an antenna assembly 110, in accordance with another preferred embodiments of the present invention. FIG. 11A is a pictorial view of the assembly, while FIGS. 11B and 11C are front and side views, respectively. In this embodiment, feed structure 25 comprises a reduced-height, planar monopole feed 112. The monopole feed is driven by a central conductor 116 of coaxial cable 86. A shield 114 of cable 86 is connected to reactive surface 28 so as to serve as a return current path. Electrically asymmetric cavity 35 is formed in this case between the rear side of monopole feed 112 and reactive surface 28. Despite the difference in feed structure 25 in the present embodiment, the effect of cavity 35 and reactive surface 28 on the electromagnetic field radiated by assembly 110 is substantially similar to that in the embodiments shown above.

FIGS. 12A and 12B are schematic pictorial and side views, respectively, of an antenna assembly 120, in accordance with still another preferred embodiment of the present invention. Feed structure 25 here comprises an inverted-F feed, having a meandered conductive line as its front surface 26, fed by conductor 116 of coaxial cable 86. Rear surface 27, serving as the ground plane of the inverted-F, is connected to shield 114. Preferably, the meandered front surface comprises a printed circuit board having a metal layer 121 that is interrupted by cuts 122 to produce the desired meander. A short-circuit strap 124 connects metal layer 121 on front surface 26 to rear surface 27.

Other feed structures and associated cavity configurations will be apparent to those skilled in the art and are considered to be within the scope of the present invention.

Furthermore, although preferred embodiments are described herein with specific reference to cellular telephones, the principles of the present invention are similar applicable to the construction of elements for shielding and redirection of radiation from devices of other types. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An antenna assembly for a communication device, the assembly comprising:
a feed structure, which has front and rear sides, and which is coupled to be driven by the device so as to radiate an electromagnetic field in a given frequency band; and
an electrically reactive surface which is positioned adjacent to the rear side of the feed structure so as to define a cavity between the feed structure and the reactive surface, thereby substantially nulling the electromagnetic field on the rear side of the feed structure.

2. An assembly according to claim 1, wherein the feed structure and reactive surface are adapted to be mounted on the communication device so that the reactive surface intervenes between the feed structure and a head of a user of the device and shields the head from the radiated field.

3. An assembly according to claim 1, wherein the reactive surface comprises an array of reactive circuit elements.

4. An assembly according to claim 3, wherein the reactive circuit elements comprise inductors.

5. An assembly according to claim 3, wherein the reactive circuit elements comprise capacitors.

6. An assembly according to claim 3, wherein the reactive surface comprises a printed circuit board having a plurality of faces in one or more layers, and wherein the reactive circuit elements comprise traces printed on at least two of the faces of the printed circuit board.

7. An assembly according to claim 6, wherein the traces are printed so as to define inductive coils.

8. An assembly according to claim 6, wherein the traces are printed so as to define parallel-plate capacitors.

9. An assembly according to claim 6, wherein the traces are printed so as to define interdigitated capacitors.

10. An assembly according to claim 3, wherein the reactive circuit elements are mutually connected in series.

11. An assembly according to claim 3, wherein the reactive circuit elements are mutually connected in parallel.

12. An assembly according to claim 1, wherein the reactive surface has a resonant response in the given frequency band.

13. An assembly according to claim 1, wherein the rear side of the feed structure is substantially planar, and wherein the reactive surface is positioned substantially parallel to the rear side of the feed structure.

14. An assembly according to claim 1, wherein the feed structure further has an upper surface, and wherein the reactive surface is configured and positioned so as to substantially cover the upper surface of the feed structure.

15. An assembly according to claim 1, wherein the front and rear sides of the feed structure define at least one resonant cavity therebetween having a resonance in the given frequency band and opening through at least one aperture in the front side of the feed structure, through which aperture the electromagnetic field radiates when the feed structure is driven by the device.

16. An assembly according to claim 15, wherein the at least one resonant cavity comprises an array of cavities.

17. An assembly according to claim 15, wherein the feed structure comprises at least one transmission line, which is configured to form the at least one resonant cavity between the front and rear sides.

18. An assembly according to claim 17, wherein the at least one transmission line defines a waveguide that forms the resonant cavity.

19. An assembly according to claim 17, wherein the at least one transmission line is configured to form a spiral shape.

20. An assembly according to claim 17, wherein the at least one transmission line is meandered.

21. An assembly according to claim 17, wherein the transmission line is configured so that the at least one resonant cavity has corners, and comprising corner elements in the corners of the resonant cavity, which are arranged to inhibit reflection of the electromagnetic radiation at the corners of the at least one cavity.

22. An assembly according to claim 17, wherein the at least one transmission line is configured so that the resonant cavity has an electrical length approximately equal to one quarter wave in the given frequency band.

23. An assembly according to claim 15, wherein the at least one aperture comprises a plurality of apertures.

24. An assembly according to claim 15, wherein the feed structure further comprises one or more lumped circuit elements coupled across the at least one aperture.

25. An assembly according to claim 15, wherein the feed structure comprises one or more fins, positioned in the at least one resonant cavity so as to enhance a capacitance of the cavity.

26. An assembly according to claim 15, wherein the feed structure comprises at least one of a dielectric material and a magnetic material, which is contained in the at least one resonant cavity.

27. An assembly according to claim 1, wherein the feed structure comprises top and side surfaces, and further comprises an awning protruding over at least one of the top and side surfaces so as inhibit leakage of the electromagnetic radiation toward the rear side of the structure.

28. An assembly according to claim 27, wherein the feed structure comprises a capacitor positioned adjacent to the awning so as to enhance inhibition of the leakage of the electromagnetic radiation toward the rear side.

29. An assembly according to claim 1, wherein the feed structure comprises a monopole feed structure.

30. An assembly according to claim 1, wherein the feed structure comprises an inverted-F feed structure.

31. An assembly according to claim 30, wherein the front side of the feed structure comprises a meandered electrical conductor.

32. An assembly according to claim 1, wherein the rear side of the feed structure is electrically conductive.

33. A method for wireless communication using a communication device operating in a given frequency band, the method comprising:
coupling a feed structure, having a front side and a rear side, to the communication device, so that the feed structure can be driven by the device to radiate an electromagnetic field in the given frequency band; and
positioning an electrically-reactive surface adjacent to the rear side of the feed structure, so as to define a cavity between the feed structure and the reactive surface, thereby substantially nulling the electromagnetic field on the rear side of the feed structure.

34. A method according to claim 33, wherein positioning the reactive surface comprises mounting the reactive surface on the communication device so that the reactive surface intervenes between the feed structure and a head of a user of the device and shields the head from the radiated field.

35. A method according to claim 33, wherein positioning the reactive surface comprises positioning an array of reactive circuit elements adjacent to the rear side of the feed structure.

36. A method according to claim 35, wherein the reactive circuit elements comprise inductors.

37. A method according to claim 35, wherein the reactive circuit elements comprise capacitors.

38. A method according to claim 35, wherein the reactive surface comprises a printed circuit board having a plurality of faces in one or more layers, and wherein positioning the array of reactive circuit elements comprises printing traces on at least two of the faces of the printed circuit board.

39. A method according to claim 33, wherein the reactive surface has a resonant response in the given frequency band.

40. A method according to claim 33, wherein the rear side of the feed structure is substantially planar, and wherein positioning the reactive surface comprises positioning the reactive surfaces substantially parallel to the rear side of the feed structure.

41. A method according to claim 33, wherein the feed structure further has an upper surface, and wherein positioning the reactive surface comprises configuring the reactive surface so as to substantially cover the upper surface of the feed structure.

42. A method according to claim 33, wherein the front and rear sides of the feed structure define at least one resonant cavity therebetween having a resonance in the given frequency band and opening through at least one aperture in the front side of the feed structure, through which aperture the electromagnetic field radiates when the feed structure is driven by the device.

43. A method according to claim 42, wherein the at least one resonant cavity comprises an array of cavities.

44. A method according to claim 42, wherein coupling the feed structure comprises configuring at least one transmission line to form the at least one resonant cavity between the front and rear sides.

45. A method according to claim 44, wherein configuring the at least one transmission line comprises configuring the at least transmission line to define a waveguide that forms the at least one resonant cavity.

46. A method according to claim 44, wherein configuring the at least one transmission line comprises configuring the at least one transmission line to form a spiral shape.

47. A method according to claim 44, wherein configuring the at least one transmission line comprises forming a meandered transmission line.

48. A method according to claim 44, wherein the transmission line is configured so that the at least one resonant cavity has corners, and comprising placing corner elements in the corners of the resonant cavity, so as to inhibit reflection of the electromagnetic radiation at the corners of the at least one resonant cavity.

49. A method according to claim 44, wherein configuring the at least one transmission line comprises configuring the at least one transmission line so that the resonant cavity has an electrical length approximately equal to one quarter wave in the given frequency band.

50. A method according to claim 42, wherein the at least one aperture comprises a plurality of apertures.

51. A method according to claim 42, wherein coupling the feed structure comprises coupling one or more lumped circuit elements across the at least one aperture.

52. A method according to claim 42, wherein coupling the feed structure comprises positioning one or more fins in the at least one cavity so as to enhance a capacitance of the resonant cavity.

53. A method according to claim 42, wherein coupling the feed structure comprises filling the at least one resonant cavity with at least one of a dielectric material and a magnetic material.

54. A method according to claim 33, wherein the feed structure comprises top and side surfaces, and wherein coupling the antenna comprises providing an awning that protrudes over at least one of the top and side surfaces so as inhibit leakage of the electromagnetic radiation toward the rear side of the structure.

55. A method according to claim 54, wherein coupling the antenna comprises positioning a capacitor adjacent to the awning so as to enhance inhibition of the leakage of the electromagnetic radiation toward the rear side.

56. A method according to claim 33, wherein coupling the feed structure comprises coupling a monopole feed structure to the device.

57. A method according to claim 33, wherein coupling the feed structure comprises coupling an inverted-F feed structure to the device.

58. An assembly according to claim 33, wherein the rear side of the feed structure is electrically conductive.
